(19) United States
(12) Patent Application Publication
(10) Pub. No.: US 2012/0085690 A1
(43) Pub. Date: Apr. 12, 2012

(54) Primary Treatment Unit and System for Maximising the Amount of Methane-Containing Biogas Collected from Sewage

(75) Inventor: Jill L. Hass, Ottawa (CA)

(73) Assignee: Clearford Industries Inc., Ottawa, ON (CA)

(21) Appl. No.: 13/127,197

(22) PCT Filed: Oct. 30, 2009
(86) PCT No.: PCT/CA2009/001542

§ 371 Date: Jul. 25, 2011

Related U.S. Application Data
(60) Provisional application No. 61/111,053, filed on Nov. 4, 2008.

(51) Int. Cl. C02F 11/04; B01D 21/02

(52) U.S. Cl. 210/188

(57) ABSTRACT

The invention provides a primary treatment unit and system for the collection of methane-containing biogas from sewage. The primary treatment unit is configured to separate sewage settling and sludge digestion into separate regions or chamber of the tank. The settling region is adapted to receive the sewage and output liquid effluent and the digestion region is adapted to receive solid components of the sewage from the settling region and output methane-containing biogas substantially generated in the digestion. The primary treatment unit is designed such that the methane-containing biogas is outputted without coming into substantial contact with sewage scum. The system further comprises a biogas collection system configured to receive the methane-containing biogas from the digestion region of the primary treatment unit.

### FIELD OF THE INVENTION

The present invention relates in general to the field of sewage methane-containing biogas collection and in particular to a primary treatment unit and a system for maximising the amount of methane-containing biogas collected from sewage.

### BACKGROUND

Digestion of sewage resulting in the generation of biogas occurs as naturally occurring micro-organisms break down and digest the sewage. In an aerobic environment, the end products of organic waste degradation are primarily CO₂ and H₂O. In an anaerobic environment, the intermediate end products of the waste degradation are primarily alcohols, aldehydes, organic acids and CO₂. In the presence of specialized microbes called methanogens, these intermediates are converted to the final end products of CH₄ and CO₂ with trace levels of H₂S.

The formation of methane by methanogens is called methanogenesis.

A simplified overall chemical equation for anaerobic digestion is given below:

C₆H₁₂O₆→3CO₂+3CH₄

Methanogens have also been shown to use carbon from other organic compounds such as formic acid, methanol, methylamines, dimethyl sulfide, and methanethiol.

If methane-containing biogas is going to be used for commercial or industrial applications it may require further treatment with scrubbing and cleaning equipment (such as amine gas treatment) to bring the H₂S levels within acceptable levels and to reduce the quantity of siloxanes. Methane-containing biogas obtained from the process can be used for a variety of applications including electricity production and chemical synthesis of compounds including methanol, etc.

Over time, sewage generally settles into three substantially distinguishable layers 1) the bottom sludge layer that contains materials that have a higher specific gravity than water, are denser than water and are derived from much of the solid sewage; 2) the middle layer comprises liquid and suspended solids, these solids are typically very small organic materials that continue to be degraded while in the liquid layer; and 3) the scum layer, substantially composed of materials that have a lower specific gravity than water, such as grease, oil, and fats. Each layer defines a unique microenvironment with different characteristics that support a distinct consortium of microorganisms.

In the sludge layer of traditional septic tanks or clarifiers, methane-containing biogas production occurs as a result of anaerobic digestion. The biogas percolates out of the sludge layer, then through the middle liquid layer and then transits through the scum layer to collect in the headspace of the septic tank or clarifier. As populations of methane-oxidizing bacteria (methanotrophs) may be present in the scum layer, at least some of the methane component of the biogas is digested into carbon dioxide as it passes through the scum layer. Prior systems for biogas generation were not designed to maximize the capture or collection of methane-containing biogases resulting from the sludge breakdown and/or to prevent the interaction between methane-containing biogas and methanotrophs in the scum layer.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

The invention provides a system for maximising the amount of methane-containing biogas collected from sewage comprising: 1) a primary treatment unit (PTU) that facilitates the segregation of the methane-consuming scum layer from both the methane-producing sludge layer and point(s) of methane collection and 2) a methane-containing biogas capture or collection subsystem.

Optionally, the system further comprises processes for enhancing methane generation operatively associated with the PTU and/or a methane-containing biogas transport subsystem.

An object of the present invention is to provide a primary treatment unit (PTU) and system for maximising the amount of methane-containing biogas collected from sewage. In accordance with an aspect of the present invention, there is provided a primary treatment unit adapted for the collection of methane-containing biogas, the primary treatment unit comprising a sewage settling region and a sludge digestion region, wherein the sewage settling region is adapted to receive the sewage and output liquid effluent and a digestion region adapted to receive solid components of the sewage from the settling region and output methane-containing biogas substantially generated in the digestion region, wherein the methane-containing biogas output does not come into substantial contact with sewage scum.

In accordance with another aspect of the invention, there is provided a primary treatment unit adapted for the collection of methane-containing biogas wherein the primary treatment unit is configured to separate sewage settling and sludge digestion into a settling region and a digestion region respectively and output methane-containing biogas substantially generated in the digestion region, wherein the methane-containing biogas output does not come into substantial contact with sewage scum.

In accordance with another aspect of the invention, there is provided a system for collection of methane-containing biogas comprising a primary treatment unit configured to separate sewage into a scum layer, liquid layer and a sludge layer, the primary treatment unit comprising a settling compartment adapted to receive the sewage and output liquid effluent and a digestion compartment adapted to receive solid components of the sewage from the settling compartment, the settling compartment having a first headspace configured to vent the tank and downstream conduits to atmospheric air to prevent hydraulic locks and to collect biogas substantially generated in the settling compartment and the digestion compartment having a second headspace, substantially separate from the first headspace, the second headspace configured to collect methane-containing biogas substantially generated in the digestion compartment; wherein the scum layer is substantially retained in the settling compartment and the sludge layer is substantially retained in the digestion compartment; and a biogas collection system operatively connected to the second headspace. Optionally, the headspaces may be separated by hydraulic seals.

In accordance with another aspect of the present invention, there is provided a primary treatment unit adapted for the collection of methane-containing biogas, the primary treatment unit being configured to separate sewage into a scum layer, liquid layer and a sludge layer, the primary treatment unit comprising a settling compartment adapted to receive the sewage and output liquid effluent and a digestion compartment adapted to receive solid components of the sewage from the settling compartment, the settling compartment having a first headspace configured to vent to atmosphere and to collect biogas substantially generated in the settling compartment and the digestion compartment having a second headspace, substantially separate from the first headspace, the second headspace configured to collect and output methane-containing biogas substantially generated in the digestion compartment.

### BRIEF DESCRIPTION OF THE FIGURES

FIG. 1(a) shows a section view of one embodiment of the two chamber PTU having a side-by-side configuration and detailing settling chamber with sewage inlet and liquid effluent outlet and digestion chamber with biogas outlet. The dividing internal wall between the settling and digestion chamber separates the settling and digestion chamber headspaces and prevents scum from entering the digestion chamber.

FIG. 1(b) shows a plan view of the embodiment of the two chamber PTU shown in FIG. 1(a)

FIG. 2 is a three-dimensional illustration of primary treatment unit of a two chamber PTU having one inlet tee offset from the center of the tank with pictorial representation of the precipitation of solid material into the digestion chamber.

FIGS. 3(a) to (e) shows various views of one embodiment of a nested two-chamber primary treatment unit detailing the settling chamber with sewage inlet and liquid effluent outlet and digestion chamber with biogas collection pipes. The dividing internal walls between the settling and digestion chamber prevents scum from entering the digestion chamber and separates the headspaces. FIG. 3(a) is a cross sectional view inlet end. FIG. 3(b) shows the longitudinal profile. FIG. 3(c) is a cross sectional view outlet end. FIG. 3(d) shows plan view. FIG. 3(e) shows a section view.

FIGS. 4(a) to (d) shows one embodiment of a circular nested two-chamber primary treatment unit detailing the settling chamber with sewage inlet and liquid effluent outlet and centrally-located digestion chamber with biogas collection pipes and separate headspace. The dividing internal wall between the settling and digestion chamber prevents scum from entering the digestion chamber.

FIG. 5(a) illustrates a sectional view of one embodiment of a primary treatment unit detailing the settling chamber with sewage inlet and liquid effluent outlet and centrally-located digestion chamber with separate headspace and biogas collection output. The dividing internal walls between the settling and digestion chamber form an inverted cone or elongated V structure that prevents scum from entering the digestion chamber and provides for a separate headspace.

FIG. 5(b) is an elevation view of the primary treatment unit shown in FIG. 5(a) detailing the sewage inlet and liquid effluent outlet.

FIG. 5(c) is a three-dimensional illustration of primary treatment unit of FIGS. 5(a) and 5(b) with a pictorial representation of the precipitation of solid material into the digestion chamber.

FIG. 6 shows various views of one embodiment of a side-by-side two-chamber primary treatment unit detailing the settling chamber with sewage inlet and liquid effluent outlet and digestion chamber with biogas collection pipes. The dividing internal wall between the settling and digestion chamber prevents scum from entering the digestion chamber and separates the headspaces.

FIG. 7 shows a cross section and longitudinal profile view of an inlet tee configuration having a 45 degree bend in both the X- and Z-direction to encourage hydraulic mixing in the tank.

FIG. 8 shows one embodiment of the system comprising on-site biogas harnessing for sludge reduction comprising a compact gas compression, flare and heating system which includes a sludge blanket heating system or coil, or other heating methodologies.

FIG. 9 shows one embodiment of the system comprising an on-site electrolysis system.

FIG. 10A shows one embodiment of the system comprising a methane mitigation means comprising a soil vent attached to the biogas collection pipe via a gooseneck pipe to convert methane into carbon dioxide, or other mitigation of greenhouse gas emissions from the biogas.

FIG. 10B shows one embodiment of the system comprising an alternative methane mitigation means.

FIG. 11 shows one embodiment of the biogas capture and/or collection system where the gas utilization center is centrally located and shared by multiple biogas generating chambers.

FIGS. 12(a) and (b) shows one embodiment of the system submerged underground in the front yard of a home. The tank lid is at grade and is made from black metal or another high emissivity material to capture solar energy as heat. The connections of the pipe are thermally fused (as opposed to using jointed pipe couplings which can degrade and leak) and there is a condensation trap between the biogas collection pipe and the SBS system so that moisture in the biogas lines does not need to be manually removed.

FIG. 13 shows one embodiment of the biogas capture and/or collection system where the gas utilization center is centrally located and shared by multiple biogas generating chambers. The figure details the collection hubs, condensation traps and the methane return main.

FIG. 14 shows the details of a condensation trap installed in relation to the small bore gravity sewer system alignment.

### DETAILED DESCRIPTION OF THE INVENTION

### Definitions

As used herein, the term ‘about’ refers to a +/−10% variation from the nominal value. It is to be understood that such a variation is always included in any given value provided herein, whether or not it is specifically referred to.

The terms “liquid effluent” and “liquid layer” are used to define substantially liquid portions of the sewage.

The term “sludge” is used to define substantially solid portions of the sewage.

The term “scum” is used to describe the layer which is substantially composed of materials that have a lower specific gravity than water.

Unless defined otherwise, all technical and scientific terms used herein have the same meaning as commonly understood by one of ordinary skill in the art to which this invention belongs.

The invention provides a primary treatment unit (PTU) and a system for maximising the amount of methane-containing biogas collected from sewage. The primary treatment unit (PTU) is configured to substantially segregate the methane-producing sludge layer and point(s) of methane-containing biogas collection from the methane-consuming scum layer. The system comprises the PTU combined with a methane-containing biogas collection/capture subsystem. The primary treatment unit (PTU) is specifically designed to maximise methane collection by facilitating the stratification or separation of the sewage into sludge, liquid and scum layers and by physically separating the scum layer from the sludge layer and the point(s) of methane containing-biogas collection and optionally by deflecting biogas bubble percolation away from scum layer and sedimentation area. The primary treatment unit can further be designed to minimize disruption of the sewage layers by strategically locating the sewage input. Alternatively, the sewage input may be localized to promote mixing such as by using an offset inlet configuration.

Methane-containing biogas produced within the PTU is collected using the methane-containing biogas collection subsystem which is operatively associated with the PTU. The methane capture/collection subsystem uses active means, passive means or some combination thereof to capture and/or collect of the methane containing biogas from the PTUs. Optionally, the system further comprises a methane-containing biogas transport subsystem for delivering the methane-containing biogas to utilization or mitigation centers.

Motive energy to passively drive biogas to a collection hub or conversion center can be generated by pressure inside a rigid PTU as the biogas generated from sludge increases in volume within the fixed headspace.

In one embodiment, the system further comprises a methane-containing biogas transport subsystem for transporting the collected biogas to a gas utilization or mitigation center, or a hub which collects multiple lines and transfers to a gas utilization or mitigation center. The biogas is optionally used at the gas utilization centers for one or more of a variety of applications including but not limited to electricity production, use as fuels and use for chemical synthesis.

Optionally, the system further comprises means for enhancing methane generation operatively associated with the PTU. Methane generation within the PTU may be enhanced by optimising the environment within the sludge layer for anaerobic digestion. Means for enhancing methane generation both increases the quantity of sludge converted to methane and the quality or the percentage of the methane fraction of the biogas. In one embodiment, methane generation is promoted by retention of at least part of the waste within the PTU for a time period sufficient for release of biogases due to degradation or by using means for promoting anaerobic processing such as heating means or a means for producing in situ hydrogen including for example electrolysis. In one embodiment, the methane generation is promoted by mixing thereby exposing fresh substrate to mature anaerobes; hydraulic mixing has been shown to be successful in offset inlet embodiments. Optionally, the processes for promoting anaerobic processing are powered by the captured methane-containing biogas.

In one embodiment, the methane-containing biogas is used locally for example to heat the sludge blanket.

### Primary Treatment Unit

The primary treatment unit facilitates the separation of the sewage into a sludge layer, liquid layer and scum layer. The primary treatment unit maximizes methane-containing biogas collection by the substantial segregation of methane production and capture/collection, from the methane consuming scum layer and bubble diffusion pathway of the sewage input. Such segregation is facilitated by a primary treatment unit design having distinct settling and digestion regions that substantially separates methane-producing anaerobic digestion of the sewage sludge and methane-containing biogas collection from the sewage input and settling zones. The segregation of methane-containing biogas bubble collection may be facilitated by way of deflection and/or redirection into a separate “headspace free” of scum. In one embodiment, there is a settling compartment or chamber adapted to receive sewage from at least one source and output liquid effluent. A distinct digestion compartment or chamber is provided and adapted to receive solid components of the sewage from the settling compartment or chamber and output methane-containing biogas from a headspace substantially separate from that of the settling compartment or chamber. The primary treatment unit in one embodiment therefore provides sufficient physical separation between the digestion chamber headspace and the methane-consuming scum layer to enable the collection of methane and minimize the exposure of methane to methanophiles or methanotrophs. In addition, the primary treatment unit may further provide for the segregation of oxygen and biogas.

In addition to those design considerations which would be standard in the design of clarifiers, septic tanks and the like, a primary treatment unit appropriate for methane collection one must address the impact of a process inside the primary treatment unit that may yield substantial quantities of explosive methane.

Methane gas is explosive when exposed to oxygen below the lower explosive level (LEL) of 4.4% by volume and above the upper explosive level (UEL) of 16% by volume. Accordingly, in one embodiment, the PTU is optionally designed to prevent excessive oxygen from entering into the anaerobic digestion chamber headspace.

Another important consideration in the design is for an appropriate active draw of methane-containing biogas from the PTU; a proper withdrawal rate of biogas through the pipe network is important, since an overdrawn system may entrain air which erases the benefits of having a sealed system to prevent biogas exposure to oxygen. In embodiments in which the biogas becomes pressurized in the PTU, biogas collection can be in a passive manner. In such embodiments, the system may further optionally comprise trip valves or other instrumentation as is known in the art to mechanically release pressure.

The primary treatment unit (PTU) in one embodiment is a closed, leak-proof container that receives sewage from one or more sources of sewage via a sewage input system or through one or more inlet(s) and outputs liquid effluent through an outlet or via an effluent output system. The kinetic energy within the flow of sewage is dissipated and the flow is slowed so that the solid components within the inputted sewage separate and settle to form a sludge layer that supports anaerobic digestion. Less dense components of the sewage rise to the surface to form a scum layer that may support methanotrophic bacteria growth. The sewage inlet(s) and/or outlet are positioned in the settling compartment or chamber to facilitate the separation of the scum layer from the methane-containing biogas producing layer and the methane-containing biogas collection points in the digestion compartment or chamber.

The dimensions of the PTU and compartments or chambers therein are determined based on its application of use and requirements thereof. A skilled worker will appreciate that the dimensions of the PTU are chosen to accommodate the primary sewage collection application for which it is used. In one embodiment of the invention, the PTU is used to receive sewage from a single residence and has a volume range between 3,600-4,500 liters. A PTU used to receive sewage from a multi-residence building may have a higher volume.

The PTU can be constructed in a variety of shapes. The physical barriers that form the settling compartment or chamber and digestion compartment or chamber and thereby segregate the scum layer and sewage input from anaerobic digestion and methane-containing biogas collection can be integral to the PTU structure or be configured therein by the introduction of separate and optionally removable, structure(s) or component(s). The use of physical barriers effectively forms two or more zones within the PTU each with separate headspaces.

In one embodiment, the PTU comprises two or more compartments in fluid communication wherein the compartments are separated by interior walls.

In one embodiment, the PTU is vertical oriented such that the distance between the sludge layer and the scum layer is increased.

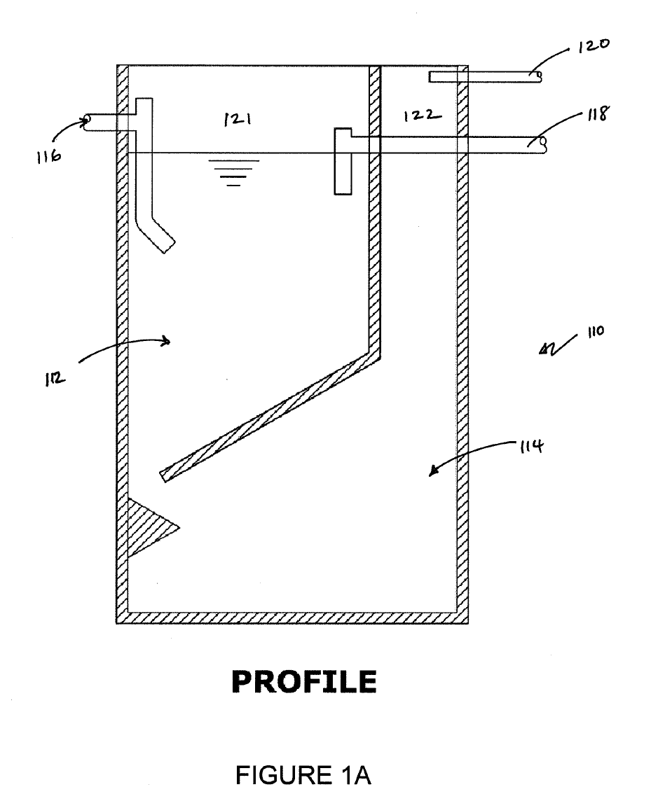

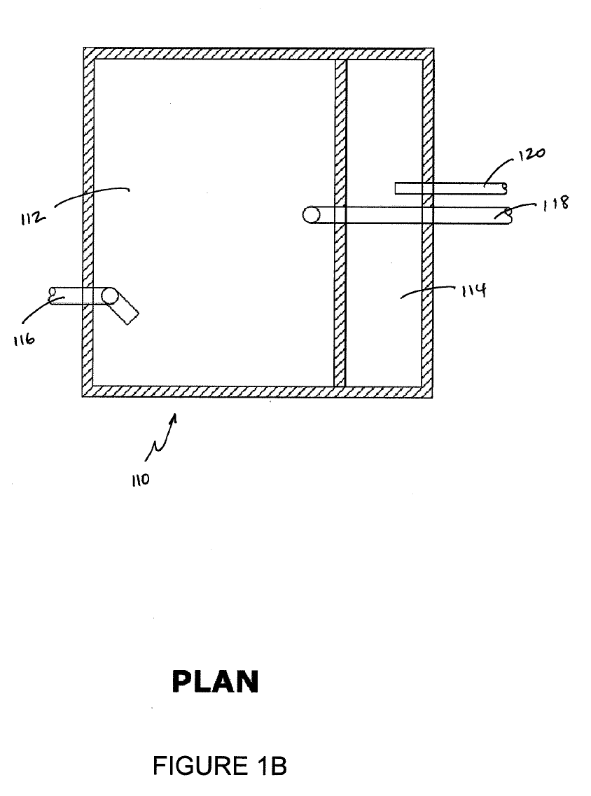

Referring to the figures, FIGS. 1 to 6 show several exemplary PTU designs for use in the methane-containing biogas collection system.

Referring to FIGS. 1(a) and 1(b), in one embodiment, the PTU (110) may be a side-by-side design consisting of a settling chamber (112) and a digestion chamber (114), each with separate headspaces (121 and 122, respectively). Sewage enters the settling chamber through a sewage inlet (116) and liquid effluent exists the settling chamber via an outlet tee (118).

Settling or sedimentation of solid components within the sewage occurs in the settling chamber and the sedimented solids slide down the inclined slope of the settling chamber floor to the opening into the digestion chamber in which the sludge blanket forms. The biogas output (120) is located in the digestion chamber headspace.

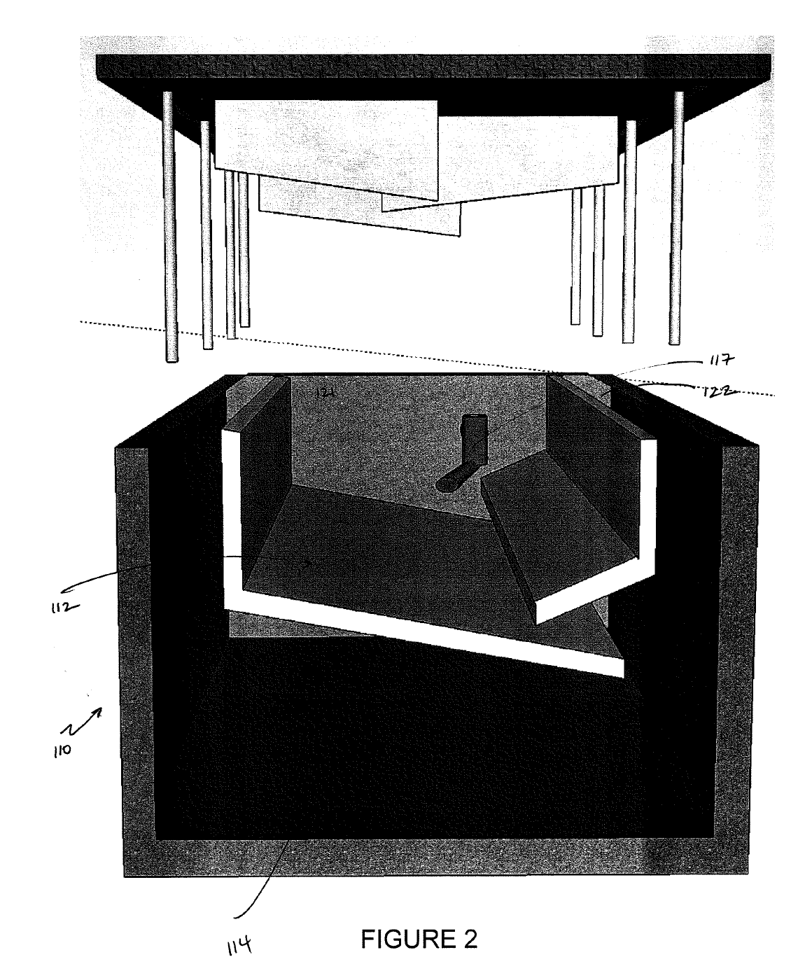

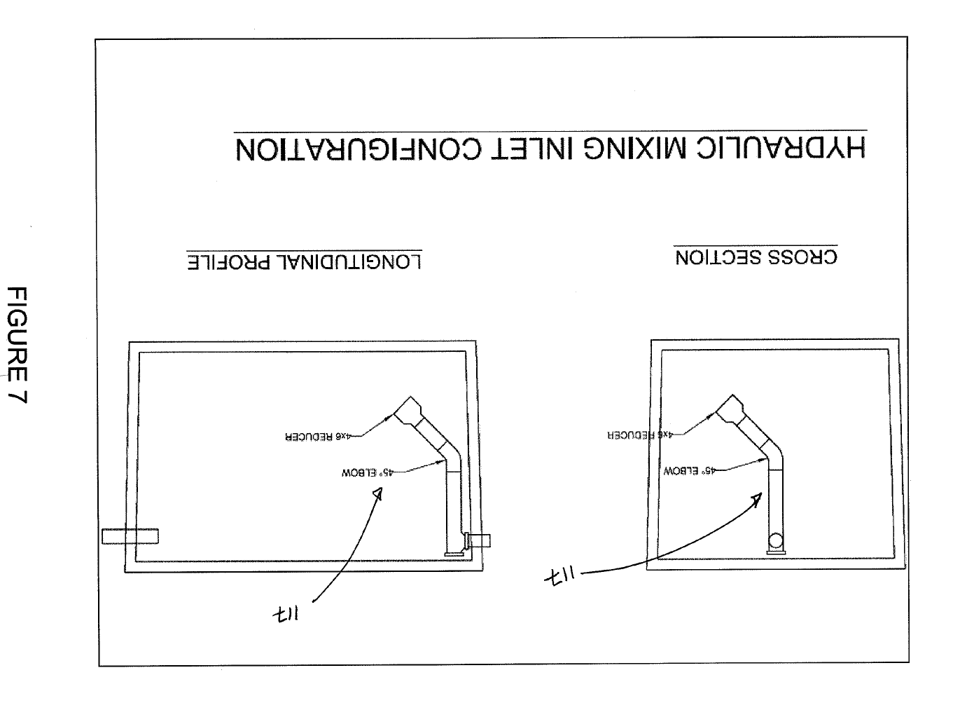

Referring to FIG. 2, in one embodiment, the PTU (110) may be a two-level design providing vertical separation consisting of a settling chamber (112) and a digestion chamber (114), each with separate headspaces (121 and 122, respectively). Sewage enters the settling chamber through a sewage inlet and liquid effluent exists the settling chamber via an outlet tee (not shown). Optionally, and as shown in FIGS. 2 and 7, the sewage inlet is an inlet tee (117) offset from the center of the tank. The inlet tee has a 45 degree bend in both the x- and z-direction to encourage hydraulic mixing in the tank.

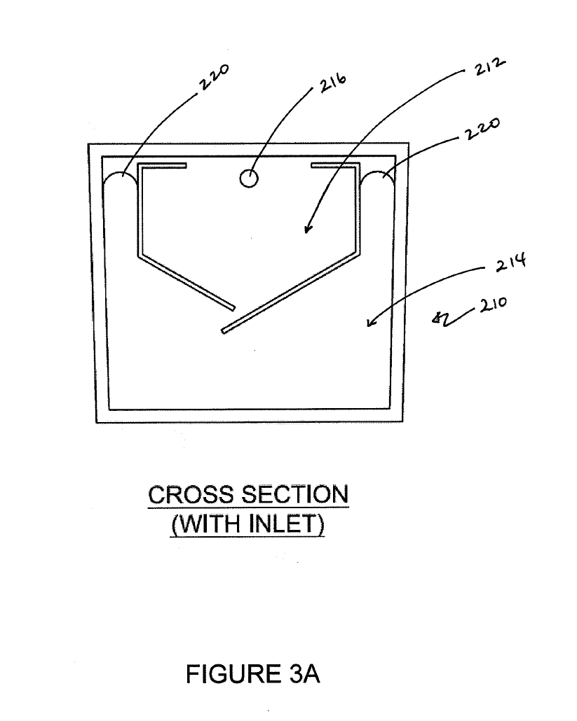

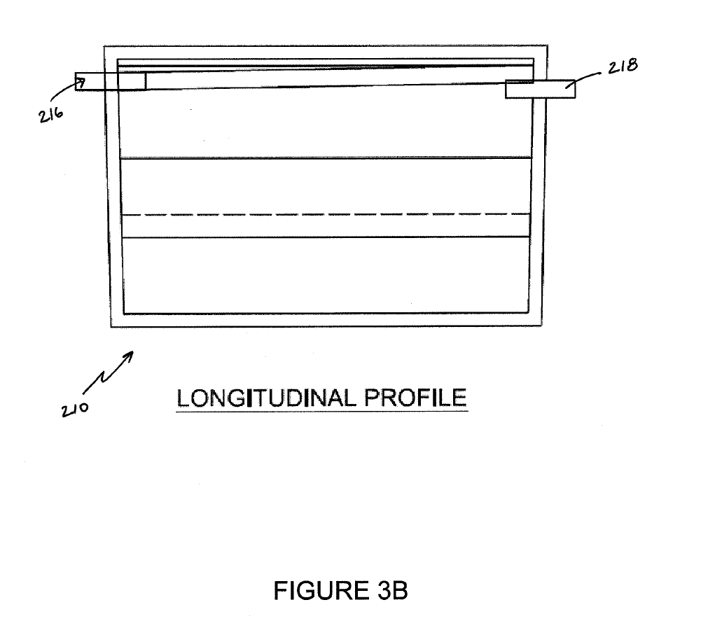

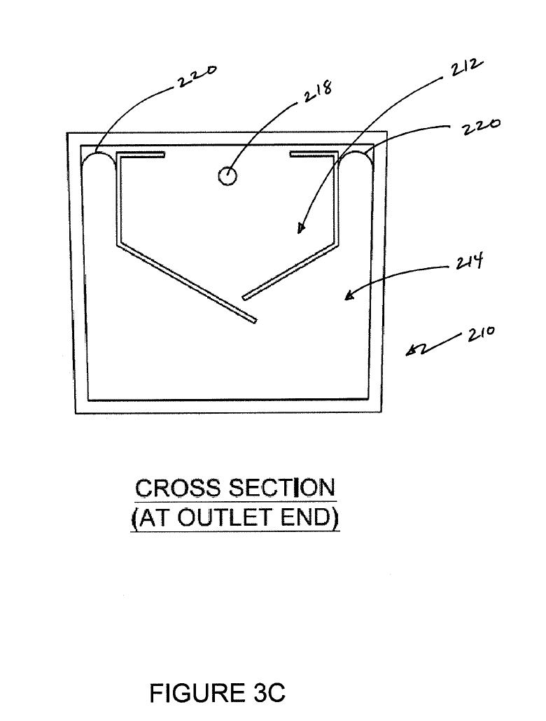

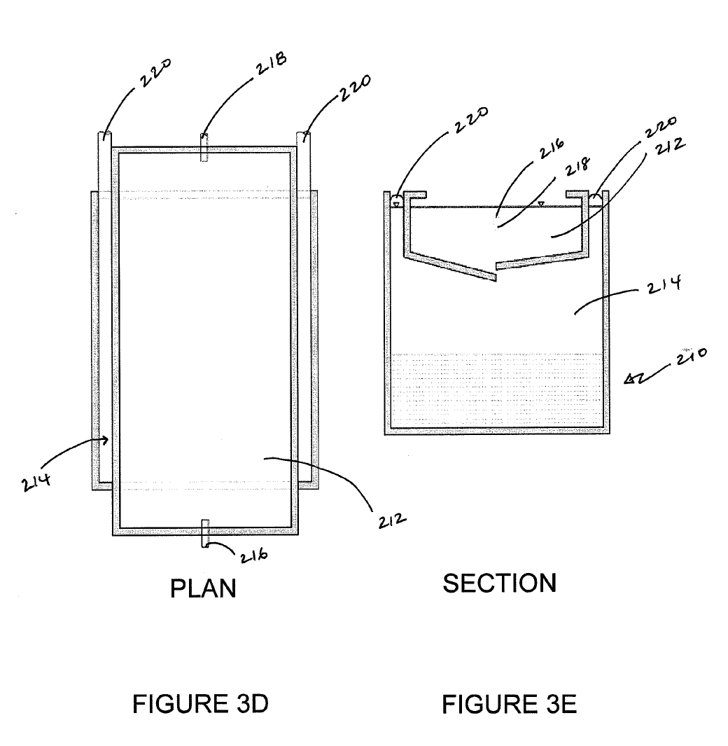

Referring to FIGS. 3(a) to 3(e), in one embodiment, the PTU (210) may be a nested design consisting of a settling chamber (212) and a digestion chamber (214). In such a design, sewage enters the settling chamber through a sewage inlet (216) and liquid effluent exists the settling chamber through a liquid effluent outlet (218). Settling or sedimentation of solid components within the sewage occurs in the settling chamber and the sedimented solids slide down the inclined bottom slopes of the settling chamber to opening into the digestion chamber in which the sludge blanket forms. Optionally, the digestion chamber has a V-shaped floor. The opening between the two chambers is optionally equipped with deflectors to prevent the flow bubbles back into the settling chamber. The biogas outputs are located in the digestion chamber and optionally comprise methane-containing biogas collection pipes (220). The two chambers have segregated headspaces which are hydraulically sealed from one another.

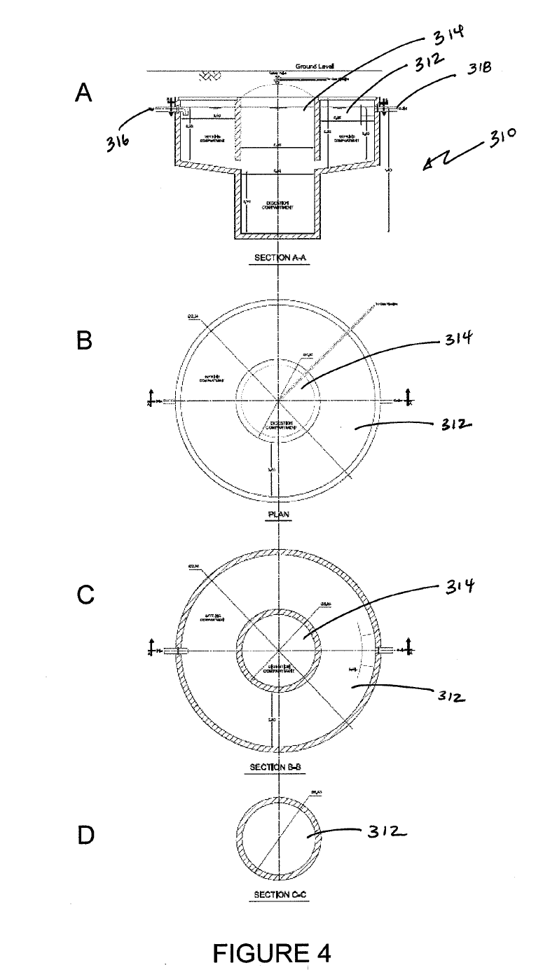

Referring to FIG. 4, in one embodiment, the PTU (310) may be a circular nested design consisting of an outer settling chamber (312) and an inner digestion chamber (314). Sewage enters the settling chamber through a sewage inlet (316) and liquid effluent exists the settling chamber through an outlet (318). Settling or sedimentation of solid components within the sewage occurs in the settling chamber and the sedimented solids slide down the inclined bottom slopes of the settling chamber to opening into the digestion chamber in which the sludge blanket forms. The opening between the two chambers is optionally equipped with deflectors to prevent the flow bubbles back into the upper chamber. The methane-containing biogas outputs are located in the headspace of the digestion chamber.

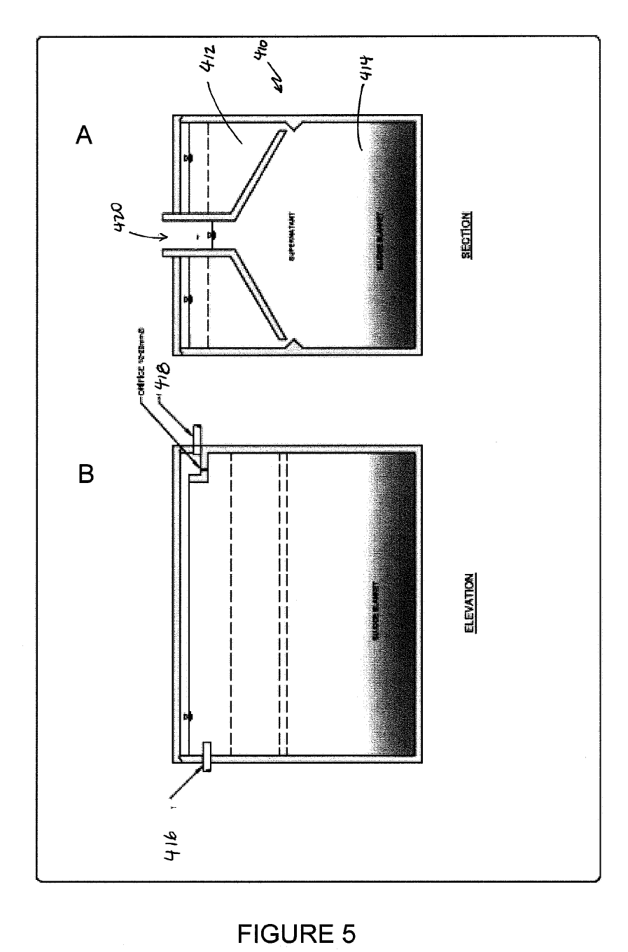

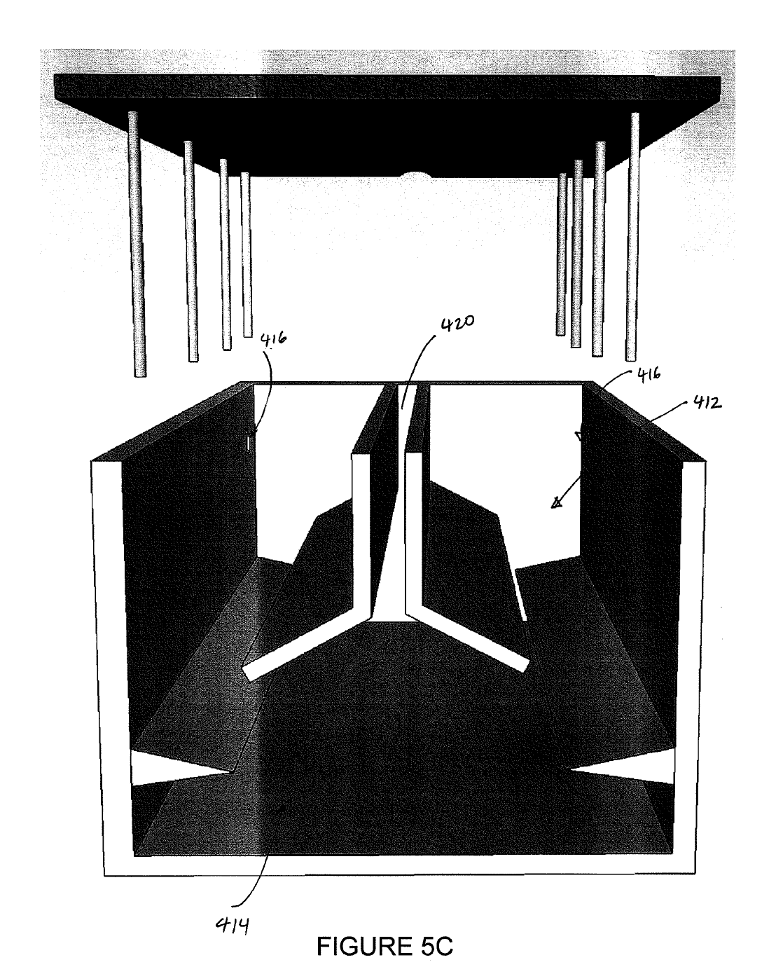

Referring to FIG. 5, in one embodiment, the PTU (410) comprises internal walls which form an inverted cone or elongated V structure separating the settling chamber (412) and the digestion chamber (414). Sewage enters the settling chamber through a sewage inlet (416) and liquid effluent exists through outlet (418). Settling or sedimentation of solid components within the sewage occurs in the settling chamber and the sedimented solids slide down the inclined slope of the inverted cone into the digestion chamber in which the sludge blanket forms. Methane-containing biogas exists through outputs (420) in the stem of the inverted cone.

With reference to FIG. 5(c), the PTU (410) may be configured with multiple sewage inlets that are along the side walls and optionally the faces of the tank. Such a configuration of inlets splits the flow without having to use a flow splitter. Such a configuration would provide for multiple connections to sewage sources (i.e. from many homes or businesses/buildings). Optionally, the inlets are equipped with inlets tees bent at 45 degrees in both the x- and z-coordinates so that there is hydraulic mixing through flow introduction in the tank.

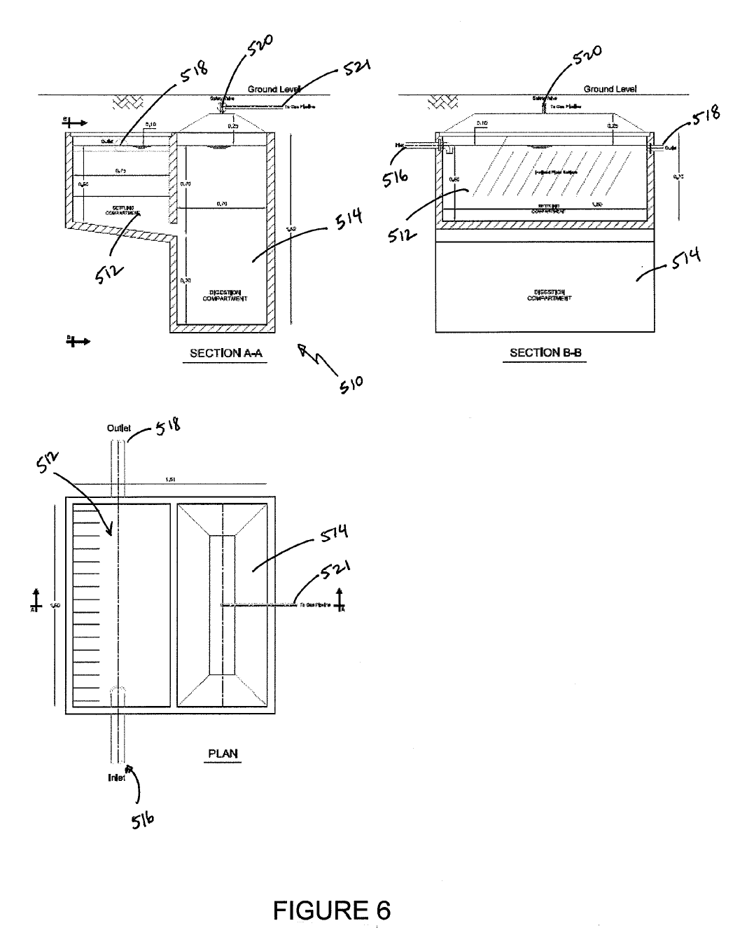

Referring to FIG. 6, in one embodiment, the PTU (510) may be a side-by-side design consisting of a settling chamber (512) and a digestion chamber (514), each with separate headspaces. The settling chamber has a slopped floor and an inlet to the digestion chamber promixal or at floor level. Sewage enters the settling chamber through a sewage inlet (516) and liquid effluent exists the settling chamber via an outlet (518). Solid components of the sewage settle in the settling chamber and the sedimented solids slide down the inclined floor into the digestion compartment. Methane-containing biogas exits through output (520) to gas pipeline (521).

The PTU optionally has one or more interior access points, such as openings and lids on the top to enable access for maintenance, repairs and other purposes that will be readily appreciated by a worker skilled in the art. If sludge pump out is necessary, access can be provided to facilitate pump out.

In one embodiment of the invention, installation of at least one lid flush with the ground level enables easy access for routine maintenance and sludge removal without disruption to the surrounding land. Additional elements may be added to the openings to prevent unauthorized or accidental entry into the PTU after installation.

The lid or top of the PTU may be installed at grade so that it is exposed to the sun's radiation. In this way, a black metal or other high emissivity material lid or top can capture solar/thermal energy to passively heat the tank thereby encouraging bacteria to convert sludge into methane-containing biogas at a higher rate.

The PTU can be constructed out of a variety of materials including concrete, plastics including PVC and PE, fiberglass, bricks, gel coat, metal, among other materials known in the art. In one embodiment, the PTU can be made of concrete, such as high strength, reinforced concrete of at least 35 mPa (4,500 psi), but may also use any suitable material such as fiberglass, high density polyethylene (HDPE), or other materials known to a worker skilled in the art that would allow for the desired level of system sealing.

In one embodiment, the PTU is manufactured at least in part from material indigenous to the installation site. To ensure that the locally manufactured/installed tank of indigenous materials is sealed, the tank can be lined with HDPE, rubber, EDPM or other materials insert or bladder to ensure quality control. The lid may be lined or painted as well. A sealant may be used to ensure that the insert is sealed to the leak-proof lid.

Optionally, the PTU is designed to resist microbial induced corrosions (MIC). Appropriate measures to limit microbial induced corrosion are well known in the art and include specialized concrete-surface paint and linings for concrete PTUs and additives to concrete mix. In one embodiment, specialized concrete-surface paint in the PTU headspace is applied to resist the microbial induced corrosion and/or the provision of headspace lining with flexible polyethylene materials including corrosion protection membranes.

In one embodiment, the PTU can be part of a high-performance sewer system (HPSS) such as described in WO2007036027.

Methane-containing biogas collection is facilitated by preventing the biogas bubbles leaving the sludge blanket to pass through scum which may house methanotrophs or methanophiles. Accordingly, in one embodiment of the invention, the PTU comprises bubble deflectors to knock down entrained suspended solids, keep biogas in the PTU, and prevent gas bubbles from washing out.

### Biogas Collection Subsystem

The biogas collection subsystem comprises one or more Biogas Capture and/or Collection Units (BCCU) for use with one or more PTUs operatively associated therewith, for the capture and/or collection of the methane-containing biogas generated therein. Optionally, the BCCUs are structured such that they create minimal disruption to the operation of the PTU and are configured so as to remove a substantial portion of the gases generated therein.

The BCCUs are intended to maximize the capture of methane-containing biogas from the PTU and are therefore placed within or connected to the digestion zoneheadspace of the PTU. This position takes into account two factors: (a) methane containing biogas generation occurs mostly where the sludge is predominantly collected and undergoes degradation; (b) biogas is lighter than air and therefore tends to collect near the top of the PTU.

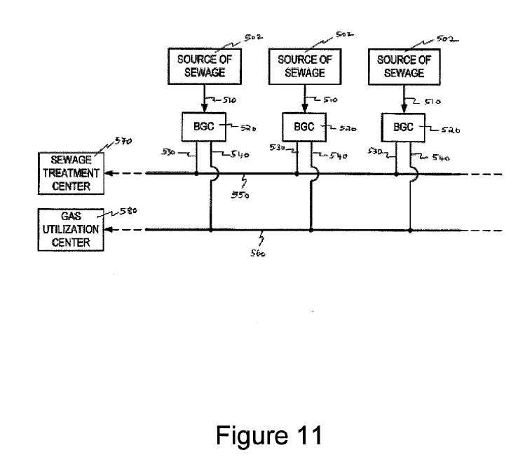

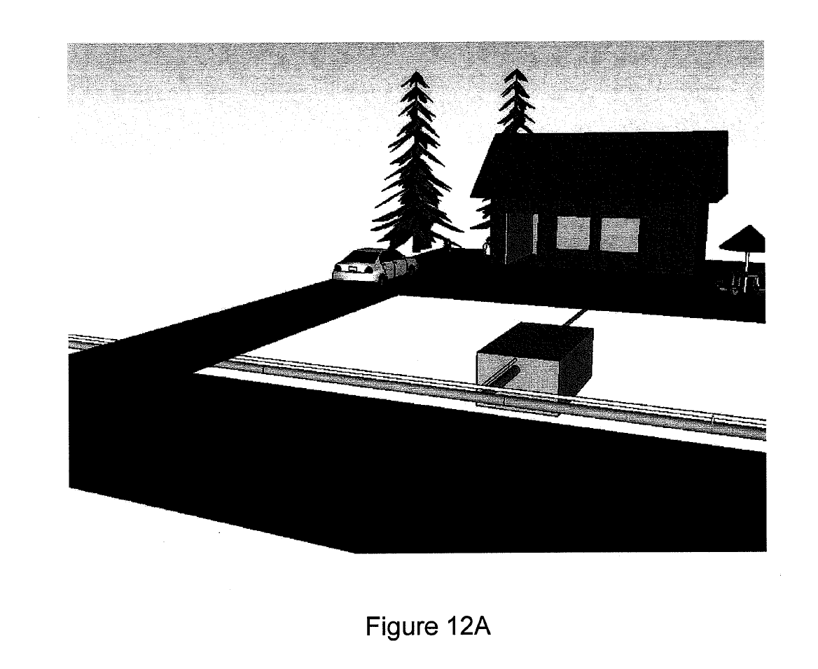

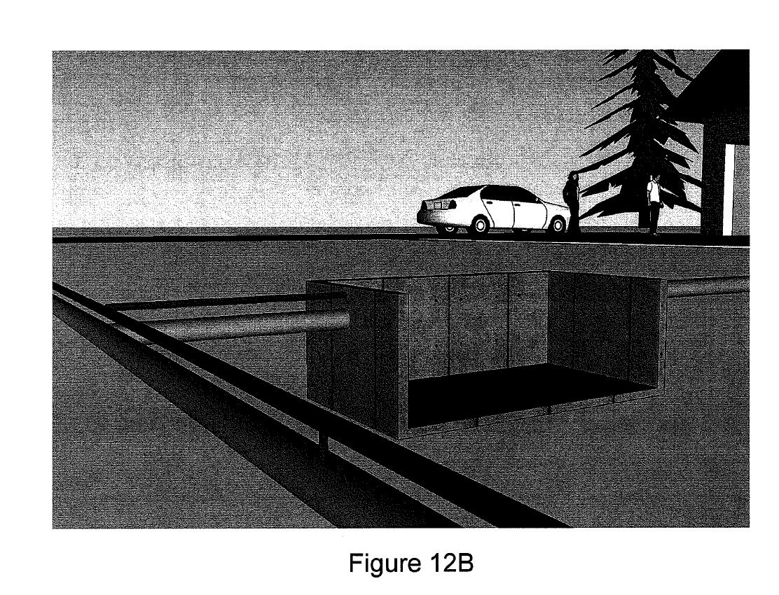

With reference to FIGS. 11 to 13, in one embodiment of the invention, the biogas streams collected by one or more BCCUs are combined together, for example, using a system of pipes. In one embodiment of the invention, the BCCUs function as stand-alone units that are harvested on an appropriate periodic basis for the biogas stored therein.

The BCCUs can use active means, passive means or some combination thereof for the capture and/or collection of the biogas from the PTUs. In one embodiment of the invention, the BCCU is passive and comprises one or more tubular conduits that are operatively linked to the PTUs for capturing the biogas within. In one embodiment of the invention, the BCCU uses an active suction technique with the tubular conduits to extract the biogas from the PTUs or collection hubs.

In one embodiment of the invention, the BCCUs are tubular conduits connected to one or more biogas transfer elements (BTE) or collection hubs for transport of the biogas to one or more gas utilization centers. In one embodiment of the invention, the BCCUs are containers such as canisters removably linked with the PTUs and designed for reversible capture of the biogas generated therein. Optionally, the containers are filled with materials designed for reversible capture of gases of a chosen molecular family.

### Tubular Conduits

In one embodiment of the invention, the BCCUs are conduits attached to the PTU using attachment assemblies. A worker skilled in the art will understand that the different types of attachment assemblies as are known in the art are intended to be included within the scope of this invention.

Optionally, the conduit acting as the BCCU is made of HDPE. The flexible nature of HDPE reduces the chances of shearing damage to the pipe. HDPE is also non-corrosive to the typical gases extracted from sewage and resistant to biological attack. Sealing means as are known to a worker skilled in the art such as mentioned earlier can be used to seal the connection between the PTU and the BCCUs.

The connection of the BCCUs to the PTU may be made using a sealingly airtight connection. Substantial air-tightness of all connections in the sewer system can be tested on site in a manner similar to that of testing the integrity of septic tanks, i.e., a vacuum test, which would be known to a worker skilled in the art. The portion of the sewer is sealed, a vacuum is applied and periodic readings with a gauge are used to determine whether the section is losing its vacuum.

### Reversible Capture Units

In one embodiment of the invention, the BCCU is a container such as a canister removably attached to the PTUs and designed for reversible capture of the biogas generated therein. In one embodiment, the BCCUs are a hybrid combination of conduits and canisters, wherein conduits operatively linked to the PTUs captures the biogas generated therein and transports it to removably attached canisters that reversibly capture the biogas. In such hybrid embodiments, the canisters may be located remote from the PTUs, for example at a centralized facility or site.

On saturation with captured biogas, the canister or its contents therein is dissociated from the PTU and optionally transported to a facility (e.g. the gas utilization center) where the biogas captured is extracted again for further processing, storage and/or utilization. A canister-based biogas collection method is well suited for stand-alone septic systems and holding tanks where the absence of a sewage collection main avoids the need for trenches.

A variety of materials can be used within the canisters for capturing the biogas either using adsorption or other mechanisms. Some of these materials are described below. A worker skilled in the art will understand that the materials listed below are merely exemplary and other materials suitable for capture of gases as are known in the art are also to be construed as included within the scope of the invention described herein.

In one embodiment of the invention, the biogas is collected in canisters packed with adsorbent materials. The biogas, comprising primarily of methane, is adsorbed in the pores and on the surfaces of the adsorbent medium. Methane molecules preferentially adsorb in pores having a diameter of 1.0-1.5 nm. In one embodiment of the invention, the canister is filled with a material that has a high volume of pores less than 1.6 nm in width as a percentage of total pore volume are used.

Activated carbon has long been used for removal of impurities and recovery of useful substances from liquids and gases because of its high adsorptive capacity, wherein “activation” refers to any of the various processes by which the pore structure is enhanced. In one embodiment of the invention, highly microporous carbon is used within the canisters for capturing the biogas. The microporous carbon can be prepared by a variety of different techniques such as further chemical activation of activated carbon. An example of a process for preparation of highly microporous carbon is given in U.S. Pat. No. 5,626,637.

The container can also be filled with materials whose lattice structures of crystalline or grain configuration is capable of reversibly trapping the methane molecules. In one embodiment of the invention, these materials have lattice structures that permit the penetration of methane molecules to the interior of the solid mass and have an inner surface activity with respect to the methane molecule such as to allow surface adhesion at least to the extent necessary to augment the trapping effect. In one embodiment of the invention, zeolites of known cage-like lattice structure, such as mentioned in U.S. Pat. No. 4,495,900 are used.

In one embodiment of the invention, the container can be filled with a sulphur-containing active carbon, produced from inexpensive aromatic precursors, such as chrysene, coal tar, and petroleum oils. An example of a process for producing such a material is given in U.S. Pat. No. 5,639,707.

In one embodiment of the invention, the BCCU canisters are filled with nanoporous carbon made from waste corn cob. In this embodiment, corn cobs are baked into carbon briquettes that trap biogas in fractal pore spaces. The fractal nature of the pores results in higher capture efficiency than other structures. The pore size affects the biogas collection capability of the carbon briquettes. Based on the type of activation procedures, about 80 different types of carbon can be produced from corn cob.

In one embodiment of the invention, biogas is collected from the PTU by promoting the formation of clathrate hydrates. Clathrate hydrates are a class of solids in which gas molecules occupy “cages” made up of hydrogen-bonded water molecules. These cages are unstable when empty, collapsing into conventional ice crystal structure, but they are stabilized by the inclusion of appropriately sized molecules within them. Most low molecular weight gases such as O₂, H₂, N₂, CO₂, H₂S, Ar, Kr, Xe and methane, as well as some higher hydrocarbons and freons will form hydrates under certain pressure-temperature conditions. Once formed, clathrates can usually be decomposed by increasing the temperature and/or decreasing the pressure.

### Means for Enhancing Methane Containing Biogas Generation

Methane generation can be promoted within the PTUs using a variety of techniques. A key factor in methane generation is the provision of sufficient time for anaerobic breakdown of waste. The amount of methane generated increases as the time for anaerobic waste breakdown increases. Methane generation can also be promoted by optimizing environmental conditions, such as temperature, pH balancing, mixing, components, nutrient levels, moisture or water-content among others.

In one embodiment, the PTU is configured not to allow any additional oxygen/air to enter into the system. Optionally, the system further comprises circumvented air venting.

### Promotion of Biogas Generation by Increasing Time for Sewage Breakdown

In embodiments of the invention where the PTU comprises of two or more compartments, the sludge portion of the sewage received from one or more sources of sewage undergoes settling in the settling compartment(s) of the PTU prior to entering the digestion compartment while the liquid effluent flows out of the PTU to an HSS, HPSS, or a leach field (in the case of a septic tank) using one or more sewage outlet pipes. As only the sludge remains in the PTU, cleanout cycles can be long. In one embodiment of the invention, the first compartment is connected to a siphon such that sludge can be extracted from the PTU during routine cleanout.

The sludge settling to the bottom of the digestion chamber of the PTU is reduced by the action of microbial digestion. Larger anaerobic digestion compartments that retain a larger volume of sludge extend cleanout cycles; act as surge suppressors to slow the flow of sewage through the system; and increase the hydraulic retention time. Additional elements including flow attenuation devices may optionally be included to increase hydraulic retention time. All these factors result in enhanced settling of the sludge and thus enhanced biogas generation.

A worker skilled in the art will understand that depending on whether the PTUs are connected to a HSS, HPSS or a leach field, the various components of the system including but not limited to the vents, pipes, joints of pipes to other components, conduits, pumping stations etc. will have differing design requirements.

### Promotion of Biogas Generation by Optimization of Environmental Conditions

Anaerobic digestion can be enhanced using several methodologies, such as by the use of additives, the use of fixed media to encourage biofilms growth and varying operational parameters including retention times, pH and temperature amongst other things.

Some of the conditions known to improve, the quantity of sludge converted to methane, the quality of the methane fraction of the biogas or the percentage of the methane within the biogas, are the following:
increasing temperature
mixing the sludge blanket
pH balancing
increasing available H⁺
optimizing carbon-nutrient ratios
microbial bioaugmentation (i.e. microbial seeding)

In one embodiment, methane generation can be promoted by optimizing environmental conditions, such as temperature, pH components, mixing, nutrient levels, moisture or water-content and hydrogen ion levels. In one embodiment of the invention, the PTU comprises a means for optimizing one or more environmental conditions to promote anaerobic digestion. Optionally, the PTU can further comprise a means for monitoring environmental conditions within the solid portion of the waste including one or more sensors, for example without limitation, temperature sensors, pH sensors, moisture sensors, aeration sensors and the like. In one embodiment of the invention, the PTU comprises a feedback system responsive to environmental cues as a means for optimizing one or more environmental conditions in response to signals received from one or more sensors.

### Control of Temperature

In one embodiment of the invention, the rate of microbial digestion of sludge in the PTU is optimized through the addition of heat. Maintaining the temperature of the sludge within an optimal range can increase the rate of digestion. Increasing the temperature inside the PTU optimizes the growth rate of the micro-organisms that break down the sludge thereby reducing sludge volume and increasing methane production. A worker skilled in the art would be aware of the optimal temperature range required for efficient microbial reactions.

For example, depending on the methanogens species present, there are two conventional temperature ranges of operation for anaerobic digestion: (a) Mesophilic: takes place optimally around 37-41° C. or at ambient temperatures around 25-45° C. with mesophiles as the digestion agents; and (b) Thermophilic: takes place optimally around 50-52° C. at elevated temperatures up to 70° C. with thermophiles as the digestion agents.

Mesophilic bacteria are more tolerant to changes in environmental conditions than the thermophiles. Therefore, mesophilic digestion systems are considered to be more stable than thermophilic digestion systems. However, the latter facilitate faster reaction rates and hence higher gas yields at increased temperatures.

In the mesophilic range (15° C.-40° C.), a general rule is that within the sludge blanket for every temperature increase by 10° C., the rate of methane production will double (Droste, 1997). Methane gas production has been witnessed at temperatures as low as 10° C. but for reasonable rates of methane production our sludge should be maintained at least at 20° C.

Increasing the temperature of the sludge blanket will both increase the rate at which microbes will digest the sludge and may alter the microbial flora found in the sludge blanket. Typically, we expect to see psychrophilic anaerobes (temperature range 10° C. to 20° C.) in the primary treatment units' sludge blanket—these microbes slowly and inefficiently convert carbonaceous material into methane gas. In contrast, heating the PTUs' sludge to more than 36° C. would encourage the colonization of very efficient and faster reacting mesophilic anaerobes which thrive in the temperature range of 25-37° C.; however, thermophilic bacteria which thrive in the 45-55° C. range are faster growing and reacting than mesophilic anaerobes, in general, are more sensitive to variations in the system and could die under minimal stresses (such as temperature dips, etc.). Additionally, operation of the clarifier in the 45-55° C. range with no active heating is not technically possible in most locations.

In one embodiment of the invention, there is provided a PTU that is insulated to increase and/or maintain a constant desired optimum temperature with reference to the ambient temperature outside of the PTU which may or may not be optimal.

In one embodiment of the invention in which the PTU is located partially or fully above ground, at least part of the PTU is painted black or manufactured from material that absorbs solar heat. The PTU's lid would be at grade and made of black metal or another high emissivity material. In one embodiment, there are metal bars attached to the lid which reach down to the sludge blanket, thereby conducting heat energy into the sludge blanket to encourage digestion.

In one embodiment of the invention, methane powered fuel cells may provide heat to the PTU.

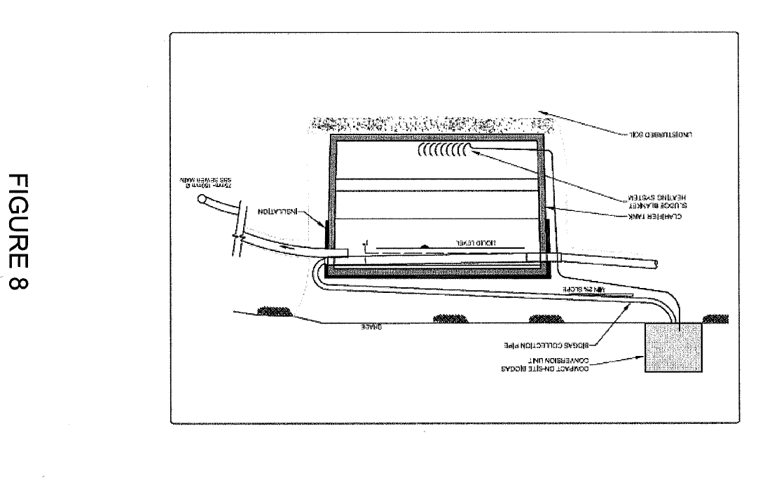

With reference to FIG. 8, in one embodiment of the invention, the temperature in the PTU is increased through a heating means. The heating means can be powered by a power source such as a solar panel array, or other source as would be readily understood by a worker skilled in the art. Alternatively, the heating means can be powered by the captured biogas. The heating means can either be located within the PTU or external to the PTU.

The system may further comprise an on-site methane harnessing system for sludge reduction comprising a gas compression flare and heating system and sludge blanket heating system. Such an on-site methane harnessing system provides for the chemical conversion of methane gas into carbon dioxide by flaring gas on-site and supplying the heat produced to the sludge blanket to expedite the sludge degradation process and extension of the pump out cycle.

In one embodiment, the system comprises a catalytic converter-linked heater such that heat generated by the catalytic converter during the conversion of methane can used to heat the sludge blanket.

In embodiments in which heating means are external to the PTU, the heating means include means for heating the walls of the PTU such as slab heaters. Alternatively, waste containing a solid component can be pre-heated prior entering a PTU.

In one embodiment, the heating means also comprises a temperature sensing means such as a thermostat. In one embodiment, the heating means also comprises a feedback system which receives information from a temperature sensor, such as a thermostat, and controls the heating means so as to maintain a preset optimal temperature.

### Means for Promoting Anaerobic Digestion

### Substrate Balancing:

Optionally, incoming sewage is modified to have both appropriate pH levels and sufficient organics with balanced carbon-nutrient ratios and nitrogen ratio.

### Seeding:

To initiate the gas production of the fresh sludge microbes to the same level as mature anaerobes, mature sludge from another clarifier's sludge blanket is added to a new tank to expedite the maturing process, thereby avoiding a lag phase. The simple advantage of seeding is that the microbial system is set into motion instantaneously and methane will be produced right away.

Moreover, various pre-treatments including thermal treatment, ozonation, sonolysis and alkaline hydrolysis or combinations thereof promote sludge solubilisation and thereby enhance mesophilic anaerobic digestion.

In one embodiment, one or more of the compartments can be equipped with one or more anaerobic fixed media systems comprising a bed or supporting material layer. The bed or supporting material provides a surface for microorganism to affix to. Appropriate supports are known in the art and can include naturally occurring supports such as pebbles or rocks or man-made supports such as bricks, ceramic, metal or plastic elements. Generally, the supports will be resistant to environmental conditions within the system.

Optionally, the anaerobic filters may be utilized to treat concentrated wastewater or used to treat dilute sewage.

### Hydraulic Mixing:

Hydraulic mixing in the tank encourages mixing of new sewage substrate with the old sludge layers accumulated at the bottom of the tank thereby exposing fresh substrate to mature anaerobes. Sewage inputs may be optionally designed to promote such hydraulic mixing. In one embodiment, the PTU sewage inputs comprise one or more offset inlet tee(s). The offset inlet tee may be offset from the center of the tank and have a bend in both the x- and z-direction. The bend can range from about 22.5 degrees to about 45 degrees. In one embodiment, the bend is 22.5 degrees. In another embodiment, the bend is 30 degrees. In another embodiment, the bend is 45 degrees. In still a further embodiment, the bend is 90 degrees.

Such an offset inlet tee configuration encourages mixing of new sewage substrate with the old sludge layers accumulated at the bottom of the tank thereby exposing fresh substrate to mature anaerobes. Computational fluid dynamic (CFD) modeling has shown that this inlet configuration can mix more than 90% of the tank's sludge blanket surface/elevation during high flow (plug) conditions. Optionally, the offset inlet tee can also be configured so that the flow is directed at interchamber walls or interior baffles to further encourage erratic flow patterns and knocking down of solids in suspension.

### Production of In Situ Hydrogen

The in situ production of hydrogen stimulates anaerobic processing. The hydrogen is consumed in anaerobic reactions and can stimulate the digestion process beyond the acidogenesis phase to methanogenesis.

Means for the in situ generation of oxygen and/or hydrogen are known in the art and can include any mechanism capable of electrolysis, including one or more electrolytic cartridges, cells or chambers. In one embodiment of the invention, the mechanism capable of electrolysis is capable of water electrolysis. In one embodiment of the present invention, the mechanism capable of electrolysis is capable of generating oxidizing agents.

The type of water electrolysis apparatus that are appropriate for use in the instant invention will vary according to the functional requirements for the system. A worker skilled in the art will appreciate that the electrolysis apparatus can function intermittently or continuously. The electrolysis apparatus can be turned on or off either in a pre-programmed manner or in response to signals, e.g. from sensors.

In one embodiment, the electrolysis apparatus comprises two or more electrodes and an energy or power source.

In one embodiment, the electrolysis apparatus comprises a process controller operatively connected to one or more electrolysis apparatus and one or more sensors. The process controller can comprise a device capable of receiving and interpreting signals from the one or more sensors, processing the received signals and sending commands to one or more electrolysis apparatus to optimize results with substantially minimum energy costs. The process controller can also perform supervisory functions, such as monitoring for system failures, etc.

In one embodiment, the process controller further comprises a sensing means for detecting pH levels and, in order to prevent acidification of the sludge due to H+ build up, enabling the electrolysis of water to be regulated in a pH-dependent manner.

### Electrolysis Apparatus

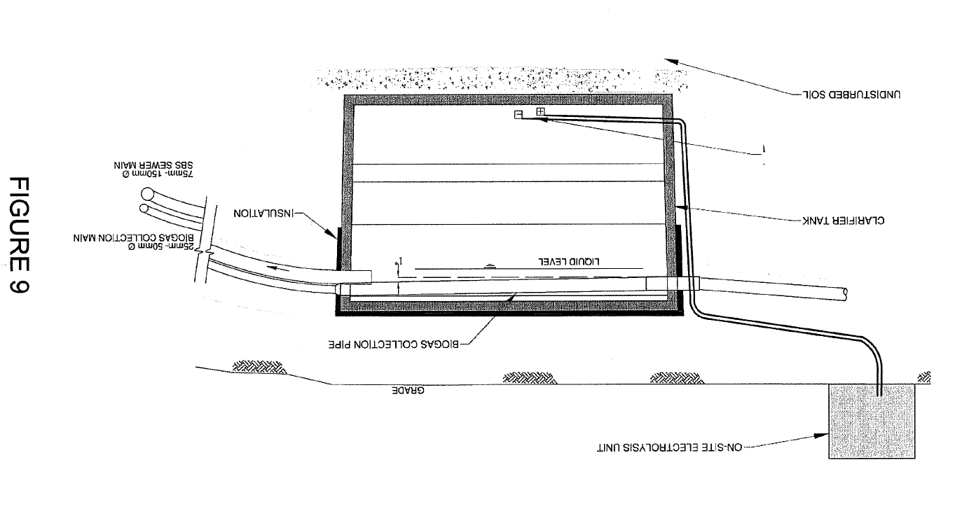

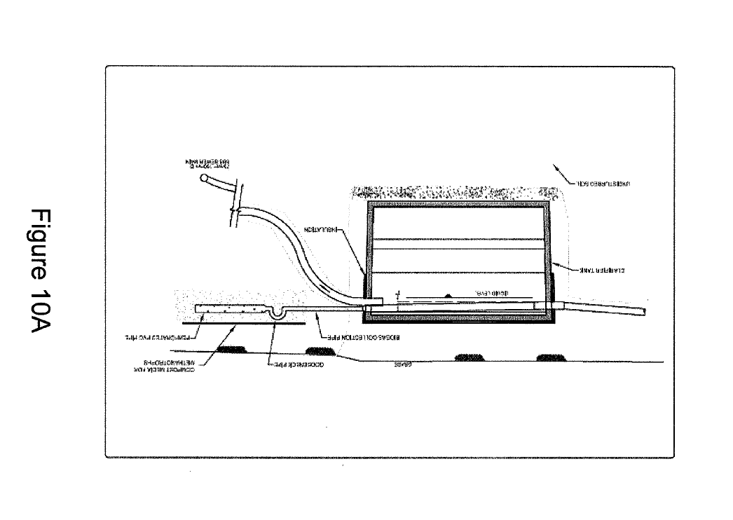

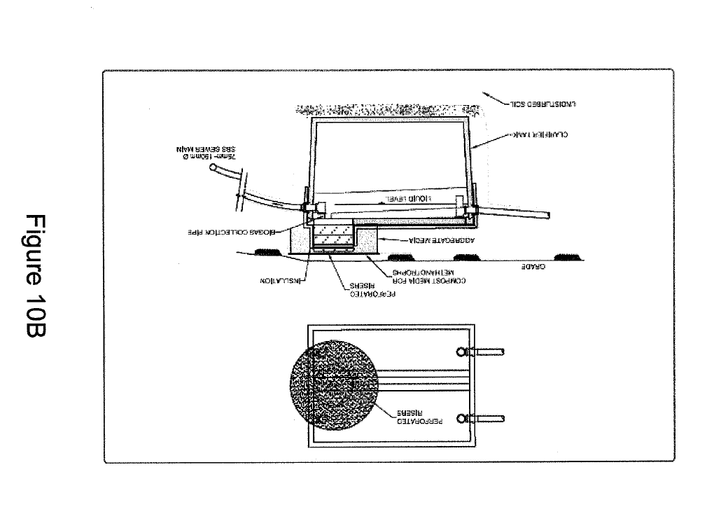

In one embodiment of the invention, the electrolysis apparatus comprises two or more electrodes located on the inner surface of the PTU or within the sludge blanket. With reference to FIG. 9, in one embodiment of the invention, two electrodes and are operatively connected to a power source, located externally to the PTU. During water electrolysis, the cathode or negative electrode generates hydrogen and the anode or positive electrode generates oxygen. Alternatively, the electrolysis unit may generate other (non-oxygen) oxidizing agents.

By promoting the digestion of the accumulated sludge within the PTU, the electrolysis apparatus indirectly serves to increase the cleanout periods. The accumulation of sludge for longer periods serves to enhance the biogas generation.

There are various types of electrodes known in the art, including flat screen, mesh, rod, hollow cylinder, plate, or multiple plates, among others. A worker skilled in the art would know which type of electrode is appropriate for use in the instant invention according to the functional requirements of the system.

Suspended solid particles adhere to bubbles that rise to the surface and out of the treatment zone. In addition, when oxygen bubbles form, inefficiencies in the system are created as oxygen fails to properly diffuse. In one embodiment of the invention, the configuration of the anode will be selected to reduce or prevent the formation of gas bubbles.

The electrode may be composed of a variety of materials. The electrode material must be sufficiently robust to withstand the elevated voltage and current levels applied during the electrolytic process of the invention, without excessive degradation of the electrode. A given electrode may be metallic or non-metallic. Where the electrode is metallic, the electrode may include platinized titanium, among other compositions, as would be readily understood by a worker skilled in the art. Where the electrode is non-metallic, the electrode may include graphitic carbon, diamond dusted boron, or can be one or more of a variety of conductive ceramic materials, as would be readily understood by a skilled worker.

The anode and cathode of the electrode cell may have a variety of different compositions and/or configurations without departing from the scope of the invention.

In one embodiment of the invention, the anode and cathode are substantially equivalent in order to facilitate bipolar operation to reduce scale build-up on the electrodes.

Electrolytic processes may generate thin films or deposits on the electrode surfaces that can lower the efficiency of the water treatment process. De-scaling of the electrodes to remove some films may be carried out by periodically reversing the polarity of operation (switching the anode and cathode plates to the opposite polarity). Automatic logic controls permit programmed or continuous de-scaling, thus reducing labour and maintenance costs.

In one embodiment of the invention, a reference electrode is integrated into the electrolysis apparatus.

In one embodiment of the invention, at least one of the one or more electrodes is substantially submerged in the sludge. In one embodiment, all of the electrodes are substantially submerged in the sludge. In one embodiment of the invention, at least one of the one or more electrodes is partially submerged in the sludge. In one embodiment, all of the electrodes are partially submerged in the sludge.

The placement of the electrodes will vary based on the system requirements. The electrodes may be in a fixed position or movably mounted. The electrodes may be mounted on the walls and/or floor of the PTU. In one embodiment of the invention, the electrodes are suspended within the sludge using means known in the art.

Appropriate energy sources for the electrolysis apparatus are known in the art and the skilled technician will know which energy source is most appropriate for configuration of the system. The energy source will deliver a controlled electrical charge having a value determined by the requirements of the system. The energy or power source may be a standard or rechargeable battery, direct AC connection or solar power, amongst others known in the art.

### On-Site Methane Mitigation

In some applications, on-site methane mitigation may be required. In such applications, the methane-containing biogas output of the primary treatment unit may be connected to methane mitigation means. On-site methane mitigation by creating a filter/device that contains (and/or encourages the colonization of methanotrophs) naturally occurring methanotrophs (typically found in compost, but other media may be used) that will convert methane gas to carbon dioxide through respiration.

These methanotrophs can be housed in an underground soil vent and/or a ring of media surrounding the riser which is finely perforated to allow gas to escape into the media but will not let soil/sand enter into the tank, a surface canister, amongst other configurations.

Integration with Other Solid Waste Reduction Systems and Methods

The system and processes described above for substantially optimizing solid waste decomposition can be integrated with other systems and processes for minimizing solid waste including, for example, pre- or post-enzymatic treatment, and others.

In one embodiment of the invention, the system and processes of the invention are integrated with systems for pre-treating sewage using electrolysis, for example as disclosed in U.S. Pat. Nos. 4,089,761 and 4,124,481.

A worker skilled in the art will readily understand that one or more of the systems for promoting microbial processing as described herein can be combined.

### Biogas Delivery to the Gas Utilization Centers

The biogas extracted using the BCCUs is optionally utilized in gas utilization centers for one or more of a variety of applications including but not limited to electricity production, co-generation, use as fuels and use for chemical synthesis. In one embodiment of the invention and referring to FIG. 11, the gas utilization centers are located on-site at the sources of waste. In one embodiment of the invention and referring to FIG. 11, the gas utilization center is a centralized facility shared by multiple PTUs.

In one embodiment of the invention, the biogas generated in the PTUs is captured using containers designed and configured to reversibly capture the biogas, that serve as BCCUs. These containers are then moved to gas utilization centers where they are treated to release the captured biogas ('desorption') therein. In hybrid embodiments, the BCCUs may be located at the gas utilization centers. A worker skilled in the art will understand that the methods for desorption vary with the type of material used in the canisters and that all such methods are to be considered within the scope of this invention. The desorption process can either be done immediately on receipt of the containers, or till such time as the biogas is to be utilized in which case the containers serve as storage devices.

Alternatively, the containers can be moved to intermediate locations where they undergo desorption and the extracted biogas is then transported to the gas utilization centers using Biogas Transport Elements (BTE), such as a system of pipes.

In one embodiment of the invention, the biogas is collected using BCCUs in the form of tubular conduits which are connected to one or more BTEs, such as a system of pipes, to gas utilization centers for further processing, storage and/or utilization. In the case of a centralized gas utilization center, the BTE serves as a gas collection main. Motive force between BTEs and gas utilization centers could be active, passive or a combination of both.

In one embodiment of the invention, the BTEs are made using flexible, pressure-rated high density polyethylene (HDPE) pipe, typically between 19-100 mm in diameter. The use of this type of pipe offers many of the advantages such as ease of installation, fewer joints between pipe sections, reduction of open excavation and surface reinstatement etc. The BTEs can also be made from a variety of other materials such as polyethylene. The use of HDPE ensures that the BTEs remain uncorroded for a design period of greater than 100 years.

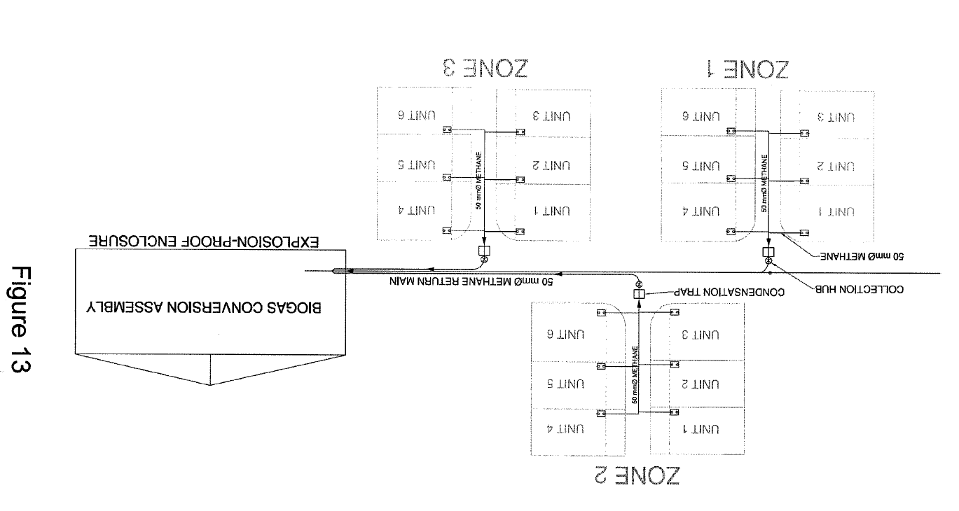

Referring to FIG. 13, which shows one embodiment of the system where the wastewater catchment area is broken up into zones and the biogas flows through either active or passive motive forces to the collection hub downstream of the catchment area. In this configuration, the moisture traps are upstream of the biogas collection hub however they may be placed at other strategic points in the system. At the collection hub, there may be instrumentation to measure and monitor the biogas quality/quantity/etc and/or ambient conditions; there may also be pumps to push/pull gas along the system depending on the topography of the catchment area and servicing conditions. From the collection hubs and/or directly from each digester adjacent to the building which it services, the biogas flows (by either active or passive motive means) to the conversion centre, either in separate pipes delivered to the plant or collected into one trunk biogas pipe merged through a series of wye connections delivering only one biogas pipe to the plant. The equipment in the conversion centre can include, but are not limited to, a multi-valve splitter, a filter or separator or scrubber, condensation and sediment traps, a drip trap, a knock out drum, a blower, a flame assembly, explosion relief valve, a flame trap assembly such as a heat exchanger or gas flame, engine/generator for cogeneration and a control panel and necessary monitoring equipment such as an oxygen analyser. Most equipment would be required to be housed within an explosion proof building, depending on the local government building regulations/rules.

In one embodiment of the invention where the gas utilization center is centralized and the PTUs are adapted for use in a HPSS, the BTE is placed in the same trench as the sewage collection mains. The use of the same trench for both the sewage collection mains and the BTE results in significant cost savings. Other services may also be added in the same trench, thus, providing “bundled services”. Moisture which collects within the underground BCCU system can be discharged into the HPSS in common trench together through the use of condensation traps (see FIG. 13).

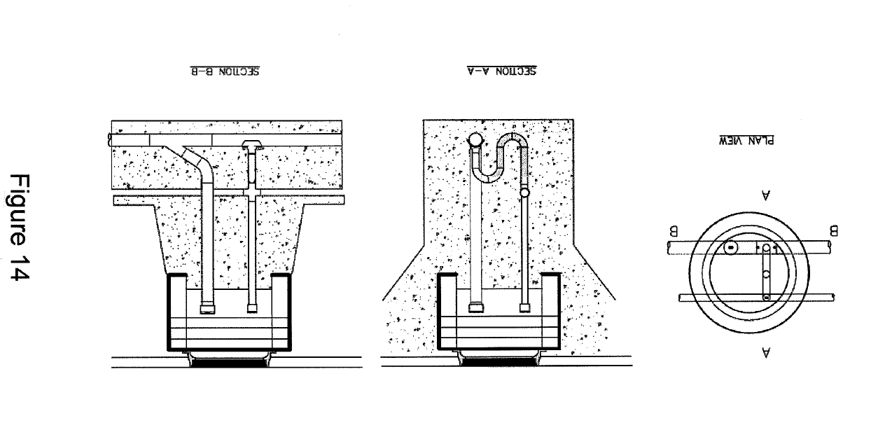

Referring to FIG. 14, which is an illustration of an exemplary condensation trap under a roadway. In embodiments in which the system is part of a small bore sewer system, optionally, moisture trapped in the biogas lines can be conveyed into a small bore sewer effluent stream without causing atmospheric air to enter into the biogas pipe network through a hydraulic plug. Most often installed at low points in the catchment area or as necessary for strategic design, the moisture traps are collection points for the cooled water which has condensed from the biogas inside the biogas piping and a gooseneck bend in the pipe contains water so that no gases pass from the biogas to the small bore sewer system or vice versa. In this way, the amount of water in the trap is always at the same elevation—when one drop enters into the gooseneck, another drop leaves the small bore sewer system side of the gooseneck configuration and deposits the water into the sanitary sewer effluent stream. These traps will be filled with water at installation and will always be full within the U-bend in a similar manner to the gas trap under most sinks. Optionally, these moisture traps can be installed along roadways with access provided to both the biogas collection system and the effluent sewer system for maintenance as prescribed or necessary. Both the biogas piping and the SBS piping can have extended standpipes from this moisture trap point to access the piping for flushing or other maintenance.

A worker skilled in the art will understand that precautions will have to be taken to ensure that there is no biogas leak to the environment either from the BTEs or at the gas utilization centers. This includes the use of butt-welding or other connection sealing method known to the skilled worker in this art to ensure that all the connections and joints are sealingly connected. The substantial air-tightness of connections between sections of BTE can be verified on site using a vacuum test as discussed above. The methane produced in the PTUs may be mixed with trace gases to instil a noticeable pungent smell that can be used to detect any methane leaks. Gases that can be used for this include but is not limited to butyl mercapton.

The BTEs may also comprise standard gas flow equipment such as pressure monitors, valves, compressors etc inserted to control the flow of gases. A worker skilled in the art will readily understand the appropriate placement of these devices along the BTEs. In one embodiment of the invention, the gas flow equipment serve to ensure a uniform pressure for the extracted gas flow. In one embodiment of the invention, these flow control devices are controlled to either operate the gas extraction process intermittently or continuously. Typical flow control mechanisms for gases such as pressure valves can be used, as will be readily understood by a worker skilled in the art.

In one embodiment, tank biogas build-up can pressurize the tank and at a maximum pressure, valves can trip, pushing biogas slug by motive force to collection hub or plant. Alternatively, valves may not be included in the design and instead the biogas continuously flows to a hub or plant.

In embodiments of the invention where predominantly methane is extracted from the PTU, it is important to ensure that there is minimal in/ex filtration into/from the BTE as the mixing of methane with air can result in a flammable mixture at concentrations of methane between 5% and 15%. Security measures may be placed within the BTEs and at the gas utilization centers to ensure that there are no explosions or unwanted leaks. These security measures include but are not limited to pressure sensors. The methane pipe collection system may be driven passively by the pressure collected in the PTU to a hub or to the conversion centre, and/or be actively pulled to the centralized conversion centre (three formations: passive-passive, active-active, or a hybrid of passive-active).

For the methane transfer system, there may be valves which can either be tripped by pressure buildup or through monitoring sensors which electronically will trip the valves. As well, condensation traps can transfer moisture collected in the biogas pipe network and release this collected water into the SBS effluent system twinned above or alongside the biogas system.

### Biogas Processing & Applications

In one embodiment of the invention, filtering means are used to remove or isolate specific gases. For example, these filtering means can be used to isolate methane. A worker skilled in the art will readily understand that these filtering means can be placed anywhere in the path of the gas flow including but not limited to the following locations: within the PTU, within the BCCUs, within the BTEs, or at the gas utilization centers.

Other post-processing steps may be applied to the biogas streams collected by the BCCUs. In one embodiment of the invention, scrubbing techniques maybe applied to remove H₂S from the biogas stream. A worker skilled in the art will readily understand that other post-processing steps as are known in the art are understood to be within the scope of the invention.

In one embodiment of the invention, predominantly methane is collected from the PTUs and transported using the BTEs to a centralized plant either for industrial use in chemical synthesis or for the production of electricity. In one embodiment of the invention, the methane is used for electricity generation by burning it as a fuel in gas turbines, steam boilers, reciprocating engines or micro-turbines. Compared to other hydrocarbon fuels, burning methane produces less CO, for each unit of heat released, and also produces the most heat per unit mass.

In one embodiment of the invention, the methane collected can be transported as fuel in liquefied form similar to liquid natural gas (LNG). Methane in the form of compressed natural gas (CNG) is also used as a fuel for vehicles and is considered to be more eco-friendly than gasoline and diesel.

Methane is also used as a feedstock for the production of hydrogen, methanol, acetic acid and acetic anhydride in the chemical industry. A worker skilled in the art will readily understand the different design issues associated with the handling of methane in the context of different downstream applications. In one embodiment of the invention, the methane collected from each PTU is pumped back upstream for applications such as electricity production for the residences.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The embodiments of the invention for which an exclusive property and privilege is claimed are defined as follows:

1. A system for extraction and collection of sewage biogas comprising
a primary treatment unit configured to separate sewage into a scum layer, liquid layer and a sludge layer, the primary treatment unit comprising a settling compartment adapted to receive the sewage and output liquid effluent and a digestion compartment adapted to receive solid components of the sewage from the settling compartment, the settling compartment having a first headspace configured to vent to atmosphere and to collect biogas substantially generated in the settling compartment and the digestion compartment having a second headspace, substantially separate from the first headspace, the second headspace configured to collect methane-containing biogas substantially generated in the digestion compartment;
wherein the scum layer is substantially retained in the settling compartment and the sludge layer is substantially retained in the digestion compartment; and
a biogas collection system operatively connected to the second headspace.

2. A primary treatment unit adapted for the collection of methane-containing biogas, the primary treatment unit being configured to separate sewage into a scum layer, liquid layer and a sludge layer, the primary treatment unit comprising a settling compartment adapted to receive the sewage and output liquid effluent and a digestion compartment adapted to receive solid components of the sewage from the settling compartment, the settling compartment having a first headspace configured to vent to atmosphere and collect biogas substantially generated in the settling compartment and the digestion compartment having a second headspace, substantially separate from the first headspace, the second headspace configured to collect and output methane-containing biogas substantially generated in the digestion compartment.

3. The system of claim 1 or the primary treatment unit of claim 2, wherein settling compartment and the digestion compartment are in a side-by-side configuration.

4. The system of claim 1 or the primary treatment unit of claim 2, wherein the settling compartment and the digestion compartment are in a nested configuration.

5. The system of claim 1 or the primary treatment unit of claim 2, wherein the settling compartment and the digestion compartment are in a circular nested configuration.

6. The system of claim 1 or the primary treatment unit of claim 2, wherein sewage is inputted through one or more tee inlets.

7. The system or primary treatment unit of claim 6, wherein each tee inlet have a configuration having a 45 degree bend in both the X- and Z-direction to encourage hydraulic mixing in the tank.

8. The system of claim 1 or the primary treatment unit of claim 2 further comprising one or more bubble deflectors.

9. The primary treatment unit of claim 2 operatively connected to a methane mitigation system.

10. The system of claim 1 or the primary treatment unit of claim 2 further comprising means for promoting anaerobic digestion.

11. A primary treatment unit adapted for the collection of methane-containing biogas, the primary treatment unit comprising a sewage settling region and a sludge digestion region, wherein the sewage settling region is adapted to receive the sewage and output liquid effluent and a digestion region adapted to receive solid components of the sewage from the settling region and output methane-containing biogas substantially generated in the digestion region, wherein the methane-containing biogas output does not come into substantial contact with sewage scum.

12. A system for extraction and collection of sewage biogas comprising
a primary treatment unit comprising a sewage settling region and sludge digestion region, wherein the sewage settling region is adapted to receive the sewage and output liquid effluent and a digestion region adapted to receive solid components of the sewage from the settling region and output methane-containing biogas substantially generated in the digestion region;
a biogas collection system configured to receive methane-containing biogas from the digestion region, wherein the methane-containing biogas output does not come into substantial contact with sewage scum.

13. A primary treatment unit adapted for the collection of methane-containing biogas wherein the primary treatment unit is configured to separate sewage settling and sludge digestion into a settling region and a digestion region respectively and output methane-containing biogas substantially generated in the digestion region, wherein the methane-containing biogas output does not come into substantial contact with sewage scum.

14. The system of claim 1 or the primary treatment unit of claim 2, wherein the first headspace and second headspace are hydraulically separate.

15. The system of claim 1 or the primary treatment unit of claim 2, wherein output of methane-containing biogas is active, passive or combination thereof.
